(19) United States
(12) Patent Application Publication
(10) Pub. No.: US 2024/0032538 A1
(43) Pub. Date: Feb. 1, 2024

(54) COMPOSITION OF FLUROCLORIDONE IN MICROEMULSION FORM

(71) Applicant: SURCOS IMPACT, Mamer (LU)

(72) Inventor: Félix Silvestre GALÁN ROMANO, Buenos Aires (AR)

(21) Appl. No.: 18/257,493

(22) PCT Filed: Jun. 16, 2021
(86) PCT No.: PCT/IB2021/055323

§ 371 Date: Jun. 14, 2023

(30) Foreign Application Priority Data
Dec. 18, 2020 (AR) P20200103543

(51) Int. Cl. A01N 43/36; A01N 25/04; A01N 25/30

(52) U.S. Cl. CPC A01N 43/36; A01N 25/04; A01N 25/30

(57) ABSTRACT

Disclosed is a flurochloridone composition in the form of a microemulsion including from 5 to 20% weight by volume (w/v) of flurochloridone, a solvent or a mixture of polar or non-polar, soluble or insoluble solvents in water, including from 35 to 45% w/v, a polar cosolvent or mixture of polar cosolvents including from 8 to 13% w/v, a mixture of non-ionic surfactants including from 6% to 12% w/v, an anionic surfactant including from 9.5% to 10% w/v, a co-adjuvant including from 2% to 15.0% w/v, water from 2.0% to 28.0% w/v and a defoamer including from 0.05% w/v to 0.5% w/v.

### FIELD OF THE INVENTION

The present invention is included in the field of herbicidal formulations of the chemical compound flurochloridone: 3-chloro-4-(chloromethyl)-1-3-(trifluoromethyl)phenyl-2-pyrrolidone, especially in the form of a microemulsion at low concentrations.

### OBJECT OF THE INVENTION

The object of the present invention is the provision of an herbicidal composition of the active ingredient flurochloridone in low concentration in the form of a microemulsion that unexpectedly requires a lower application dose of the active ingredient per unit of crop area to which it is applied, achieving equal or better benefits than concentrated commercial formulations thereof.

### BACKGROUND OF THE INVENTION

Flurochloridone is a pre- and post-emergent herbicide used to control a wide spectrum of weeds, especially those with broad leaves.

Its systemic action is based on the penetration by cotyledons, young leaves or roots in order to completely translocate towards the leaves and stems, causing the death of the weeds.

Among the favorable characteristics of flurochloridone, it was found that it is activated with low soil moisture and is not washed away by the effect of rain.

The document closest to the present development corresponds to patent U.S. Pat. No. 9,339,030 which refers to a ready-to-use foamable composition that contains the product flurochloridone among its components, however there is no disclosure in said document about a possible obtaining of a flurochloridone composition in microemulsion form (ME).

In general, flurochloridone is marketed at 25% weight by volume as an emulsifiable concentrate (EC).

No antecedents have been found for commercialized products that comprise the compound flurochloridone as an active principle in compositions in the form of a microemulsion, therefore the present development implies an innovation in the art.

### SUMMARY OF THE INVENTION

As a main variant of the invention mode, a flurochloridone composition in the form of a microemulsion is preferred, comprising from 5 to 20% weight by volume (w/v) of flurochloridone, a solvent or a mixture of polar or non-polar, soluble or insoluble solvents in water, comprising from 35 to 45% w/v, a polar cosolvent or mixture of polar cosolvents comprising from 8 to 13% w/v, a mixture of non-ionic surfactants comprising from 6% to 12% w/v, an anionic surfactant comprising from 9.5% to 10% w/v, a co-adjuvant comprising from 2% to 15.0% w/v, water from 2.0% to 28.0% w/v, and a defoamer comprising from 0.05% w/v to 0.5% w/v.

In the flurochloridone composition in the form of a microemulsion according to the above-indicated main variant, the solvent or solvent mixture that is polar or nonpolar, soluble or water-insoluble, comprising 35 to 45% w/v is selected as the solvent water-soluble cyclohexanone, dimethylsulfoxide (DMSO), dioxolane, methyl ethyl ketone (MEK), acetone, and as a solvent water-insoluble dibasic ester (DBE), or xylene; or mixtures thereof.

In the flurochloridone composition in the form of a microemulsion according to the indicated main variant, the polar cosolvent is selected from N-methylpyrrolidone, N-octylpyrrolidone or a mixture thereof.

In the flurochloridone composition in the form of a microemulsion according to the indicated main variant, the mixture of non-ionic surfactants comprising from 6% to 12% w/v is selected from polyalkylene oxide block copolymer (Atlas G5002L®) and 10 mol EO nonylphenol ethoxylate.

In the flurochloridone composition in the form of a microemulsion according to the variant above, the amount of polyalkylene oxide block copolymer in the composition ranges between 3.0% w/v to 7.0% w/v; or the amount of 10 mol EO nonylphenol ethoxylate in the composition ranges between 3% w/v to 5.0% w/v.

In the flurochloridone composition in the form of a microemulsion according to the main variant, where the anionic surfactant is selected from calcium dodecylbenzenesulfonate (FS Ca) at 60% or 70% w/w in isobutanol.

The flurochloridone composition in the form of a microemulsion according to the main variant, the co-adjuvant is selected from soybean oil fatty acid methyl esters (FAME) of vegetal oil as soybean oil, coconout oil, palm oil, palm kernel oil, corn oil, olive oil or oilseed rape and tallow.

In the flurochloridone composition in the form of a microemulsion according to the main variant, the defoamer comprises a silicone defoamer.

In the flurochloridone composition in the form of a microemulsion according to the stated main variant, it is preferred that it comprises the following list of components:

| Component | % w/v |
|---|---|
| Cyclohexanone | 42.50 |
| N-methylpyrrolidone | 8.50 |
| Flurochloridone | 12.50 |
| FAME | 11.00 |
| Polyalkylene oxide block copolymer | 6.00 |
| 10 EO Nonylphenol | 4.80 |
| FS Ca 70% | 9.00 |
| Water | 6.00 |
| Defoamer | 0.05 |

In the flurochloridone composition in the form of a microemulsion according to the stated main variant, it is preferred that it comprises the following list of components:

| Component | % w/v |
|---|---|
| Cyclohexanone | 40.00 |
| N-methylpyrrolidone | 8.00 |
| Flurochloridone | 5.00 |
| FAME | 15.00 |
| Polyalkylene oxide block copolymer | 6.00 |
| 10 EO Nonylphenol | 5.00 |
| FS Ca 70% | 9.00 |
| Water | 15.00 |
| Defoamer | 0.5 |

In the flurochloridone composition in the form of a microemulsion according to the stated main variant, it is preferred that it comprises the following list of components:

| Component | % w/v |
|---|---|
| Cyclohexanone | 45.00 |
| N-methylpyrrolidone | 13.00 |
| Flurochloridone | 20.00 |
| FAME | 2.00 |
| Polyalkylene oxide block copolymer | 7.00 |
| 10 EO Nonylphenol | 5.00 |
| FS Ca 70% | 9.50 |
| Water | 2.00 |
| Defoamer | 0.5 |

In the flurochloridone composition in the form of a microemulsion according to the stated main variant, it is preferred that it comprises the following list of components:

| Component | % w/v |
|---|---|
| Cyclohexanone | 35.00 |
| N-methylpyrrolidone | 5.00 |
| Flurochloridone | 5.00 |
| FAME | 15.00 |
| Polyalkylene oxide block copolymer | 3.00 |
| 10 EO Nonylphenol | 3.00 |
| FS Ca 70% | 6.00 |
| Water | 28.00 |
| Defoamer | 0.5 |

### BRIEF DESCRIPTION OF THE FIGURES

FIG. 1: refers to Precipitations and evapotranspiration Freyre Site Historical series vs. Camp 15-16.

FIG. 2: shows Var 1. Results for emergencies of Viola arvensis, number of seedlings/m2 post-treatment (absolute average values of three repetitions, 15 DAA and 30 DAA).

FIG. 3: shows Var 2. Results for emergencies of Carduus sp., number of seedlings/m2 post-treatment (absolute average values of three repetitions, 15 DAA and 30 DAA).

FIG. 4: shows Var 3. Results for emergencies of Chenopodium album, number of seedlings/m2 post-treatment (absolute average values of three repetitions, 15 DAA and 30 DAA).

FIG. 5: shows Var 4. Results for emergencies of Amaranthus quitensis, number of seedlings/m2 post-treatment (absolute average values of three repetitions, 15 DAA and 30 DAA).

FIG. 6 shows Var 5. Results for emergencies of Gomphrena pulchella, number of seedlings/m2 post-treatment (absolute average values of three repetitions, 15 DAA and 30 DAA).

### DETAILED DESCRIPTION OF THE INVENTION

The present invention relates to compositions of flurochloridone in the form of a microemulsion with a concentration of the active principle between 5 and 20% w/v.

The technical grade flurochloridone is a solid that is marketed at a concentration of 96-97 p/p with a very low solubility in water of 21.9 ppm (mg/L) at 20° C.

Microemulsion compositions are formulations containing very small emulsified oily droplets, which give rise to a transparent formulation that is thermodynamically stable in a wide range of temperatures because the droplets have a very small size that varies in a range of 0.01. μm to 0.05 μm in diameter. Therefore, unlike other emulsion systems, where oily droplets can coalesce slowly over time causing phase separation, this does not happen in microemulsion formulations.

Microemulsions are made up of immiscible liquids and appropriate amounts of surfactant and cosurfactant.

The present microemulsion formulation of flurochloridone is composed of water immiscible liquids that comprise an organic aprotic solvent of a water-soluble formulation selected from cyclohexanone, dimethylsulfoxide (DMSO), dioxolane, methyl ethyl ketone (MEK), acetone, and as a water-insoluble solvent dibasic ester (DBE), or xylene.

Dibasic ester comprises a mixture of 10 to 30% w/w dimethyl adipate with 40 to 70% w/w dimethyl glutarate and 10 to 30% w/w dimethyl succinate.

The present formulation further comprises a water-soluble cosolvent selected from N-methylpyrrolidone and N-octylpyrrolidone, or their mixture.

Among the surfactants for the formulation of the flurochloridone microemulsion composition of the present development are preferred: mixture of non-ionic surfactants such as polyalkylene oxide block copolymer marketed as ATLAS G5002L® and 10 mol EO nonylphenol ethoxylate.

A preferred anionic surfactant is calcium dodecylbenzenesulfonate (FS Ca) at 60% or 70% w/w in isobutanol.

The flurochloridone microemulsion also contains fatty acid methyl esters of vegetal oil as soybean oil, coconout oil, palm oil, palm kernel oil, corn oil, olive oil or oilseed rape and tallow as co-adjuvants; the co-adjuvants give them an anti-evaporation and adherence power to agricultural applications; this property is essential to avoid the separation into phases of active ingredients within the mixing tank at the application time of agrochemicals.

In order to avoid the foam formation during the formulation of the flurochloridone composition in the form of a microemulsion, defoamers selected from silicones are added, among others.

Finally, the flurochloridone composition in the form of a microemulsion contains water that facilitates the formation of a transparent formulation in the present case.

Based on the previous components, the following microemulsions were prepared, where the amounts in % w/v are described in the following tables:

### 1) Flurochloridone Microemulsion 5% w/v

| Component | % w/v |
|---|---|
| Cyclohexanone | 35.00 |
| N-methylpyrrolidone | 5.00 |
| Flurochloridone GT | 5.20 |
| FAME | 15.00 |
| Polyalkylene oxide block copolymer | 3.00 |
| 10 EO Nonylphenol | 3.00 |
| FS Ca 70% | 6.00 |
| Water | 28.00 |
| Defoamer | 0.5 |

### 2) Flurochloridone Microemulsion 12.5% w/v

| Component | % w/v |
|---|---|
| Cyclohexanone | 42.50 |
| N-methylpyrrolidone | 8.50 |
| Flurochloridone GT | 13.00 |
| FAME | 11.00 |
| Polyalkylene oxide block copolymer | 6.00 |
| 10 EO Nonylphenol | 4.80 |
| FS Ca 70% | 9.00 |
| Water | 6.00 |
| Defoamer | 0.05 |

### 3) Flurochloridone Microemulsion 5% w/v

| Component | % w/v |
|---|---|
| Cyclohexanone | 40.00 |
| N-methylpyrrolidone | 8.00 |
| Flurochloridone GT | 5.20 |
| FAME | 15.00 |
| Polyalkylene oxide block copolymer | 6.00 |
| 10 EO Nonylphenol | 5.00 |
| FS Ca 70% | 9.00 |
| Water | 15.00 |
| Defoamer | 0.5 |

### 4) Flurochloridone Microemulsion 20.0% w/v

| Component | % w/v |
|---|---|
| Cyclohexanone | 45.00 |
| N-methylpyrrolidone | 13.00 |
| Flurochloridone GT | 20.80 |
| FAME | 2.00 |
| Polyalkylene oxide block copolymer | 7.00 |
| 10 EO Nonylphenol | 5.00 |
| FS Ca 70% | 9.50 |
| Water | 2.00 |
| Defoamer | 0.5 |

### 5) Flurochloridone Microemulsion 12.5% w/v

| Component | % w/v |
|---|---|
| Cyclohexanone | 42.50 |
| N-octylpyrrolidone | 8.50 |
| Flurochloridone GT | 13.00 |
| FAME | 11.00 |
| Polyalkylene oxide block copolymer | 6.00 |
| 10 EO Nonylphenol | 4.80 |
| FS Ca 70% | 9.00 |
| Water | 6.00 |
| Defoamer | 0.05 |

### 6) Flurochloridone Microemulsion 12.5% w/v

| Component | % w/v |
|---|---|
| Xylene | 42.50 |
| N-methylpyrrolidone | 8.50 |
| Flurochloridone GT | 13.00 |
| FAME | 11.00 |
| Polyalkylene oxide block copolymer | 6.00 |
| 10 EO Nonylphenol | 4.80 |
| FS Ca 70% | 9.00 |
| Water | 6.00 |
| Defoamer | 0.05 |

In all the previous formulations, the technical grade drug was added in order to obtain the desired weight by volume concentrations.

The previous formulations in microemulsions showed excellent stability, passing the water emulsion tests without separation of components.

### COMPARATIVE TESTS

The following tests were carried out with the previous microemulsion formulations, which were carried out confidentially until the moment of filing of this application:

### 1) Comparative Test of Herbicides in Sunflower Pre-Emergence (Broad Leaf) (Flurochloridone 12.5% ME) 14-15

Products to evaluate: (Flurochloridone 12.5% ME) in pre-emergence of sunflower cultivation.

### Proposed Treatments

| Nº | Treatments |
|---|---|
| 1 | Absolute witness: without control |
| 2 | Dose 1: 4 l/ha (Flurochloridone 12, 5% ME) |
| 3 | Dose 2: 5 l/ha (Flurochloridone 12, 5% ME) |
| 4 | Dose 3: 6 l/ha (Flurochloridone 12, 5% ME) |
| 5 | Dose 4: 7 l/ha (Flurochloridone 12, 5% ME) |
| 6 | Chemical witness: 4 1/ha (Flurochloridone 25% EC) |

Work report:
a. Cultivation: Sunflower Paraiso 1000 CL Plus sown on Oct. 21, 2014
b. Site: La Dulce (Necochea district) Province of Buenos Aires.
c. Soil moisture: Good soil moisture but very little stubble cover.
d. Application characteristics: The application was carried out on Oct. 22, 2014. A manual backpack was used at a constant pressure of 35 lb using CO₂ with 11002 tablets and an application volume of 140 L/ha.

The wind was 20 km/h in favor, relative humidity of 39% and 32° C. of ambient temperature.
e. Weeds present: The lot was clean at the time of application due to a control carried out with glyphosate for 35 days. But the presence of Sonchus oleraceus SONOL “cerraja” and of Euphorbia dentata “Lecherón” was known in a given sector.
f. Measured variables: On November 27 and Jan. 6, 2015, visual control evaluations were carried out for each present weed. The data was subjected to an analysis of variance and the means were compared with Fisher's test (DMS) with a p<0.05.
g. Results

As a first result, it must be said that phytotoxicity symptoms were observed in the crop in treatments 4,5 and 6. The symptoms were thickening of the veins and chlorosis in the first leaves, but these symptoms were diluted with time.

Table 1 shows the Lecherón control at 35 days after application. Although the density of the weed was not very important in the test, very good controls could be seen with all the evaluated doses of the herbicide. Likewise, treatment 5 was highlighted, ending with totally clean plots on this weed.

TABLE 1
Test in control % of Lecheron at 35 days after application

| N° | Treatments | Lecherón 11/27 | | | |
|---|---|---|---|---|---|
| 1 | Absolute witness: without control | 0.00 | A | | |
| 2 | Dose 1: 4 l/ha (Flurochloridone 12,5% ME) | 93.33 | | B | |
| 3 | Dose 2: 5 l/ha (Flurochloridone 12,5% ME) | 96.33 | | B | C |
| 4 | Dose 3: 6 l/ha (Flurochloridone 12,5% ME) | 97.67 | | B | C |
| 5 | Dose 4: 7 l/ha (Flurochloridone 12,5% ME) | 99.00 | | | C |
| 6 | Chemical witness: 4 l/ha | 96.00 | | B | C |
| | (Flurochloridone 25% EC) | | | | |
| | CV % | 3.24 | | | |
| | DMS | 4.74 | | | |

Different letters between columns indicate meaningful differences between treatments.

The control of SONOL births is shown in Table 2. In general, the control was good for all the doses evaluated, but at 70 days the control of dose 1 decreased. This data is very interesting because this weed has its presence and abundance greatly increased in recent years, being one of the most problematic weeds in sunflower cultivation.

TABLE 2
Test in control % of Sonchus oleraceus (SONOL) at
35 and 76 days after application

| N° | Treatments | 11/27 | | | | 1/6 | | | |
|---|---|---|---|---|---|---|---|---|---|
| 1 | Absolute witness: l | 0.00 | A | | | 0.00 | A | | |
| | without contro | | | | | | | | |
| 2 | Dose 1: 4 l/ha | 90.33 | | B | | 80.00 | | B | |
| | (Flurochloridone | | | | | | | | |
| | 12,5% ME) | | | | | | | | |
| 3 | Dose 2: 5 l/ha | 96.00 | | | C | 91.00 | | B | C |
| | (Flurochloridone | | | | | | | | |
| | 12,5% ME) | | | | | | | | |
| 4 | Dose 3: 6 l/ha | 99.00 | | | C | 93.33 | | | C |
| | (Flurochloridone | | | | | | | | |
| | 12,5% ME) | | | | | | | | |
| 5 | Dose 4: 7 l/ha | 97.67 | | | C | 96.33 | | | C |
| | (Flurochloridone | | | | | | | | |
| | 12,5% ME) | | | | | | | | |
| 6 | Chemical witness: 4 l/ha | 99.00 | | | C | 95.00 | | | C |
| | (Flurochloridone | 2.23 | | | | 8.81 | | | |
| | 25% EC) | | | | | | | | |
| | CV % | 3.25 | | | | 12.17 | | | |
| | DMS | | | | | | | | |

### Final Comments

The highest doses (treatments 4, 5 and 6) showed symptoms of phytotoxicity in the first leaves of the crop, although it was temporary, it should be taken into account for a future recommendation.
Excellent controls of Lecherón were observed with the doses evaluated.
For Sonchus, the controls were very good from dose 2 of the herbicide.

### 2) Comparative Test of Herbicides in Sunflower Pre-Emergence (Flurochloridone 12.5% ME) 15-16

Comparative test of herbicides in Sunflower Pre-emergence (Flurochloridone 12.5% ME) Campaign 2015/16

Products to evaluate: Flurochloridone 12.5% in Sunflower pre-emergence

Tests design: Complete randomized blocks with plots 3 m wide by 8 m long and 3 replications.

### Proposed Treatments

### Treatments

| | |
|---|---|
| 1 | Absolute witness |
| 2 | Dose 1: 3.5 l/ha (Flurochloridone 12.5% ME) |
| 3 | Dose 2: 4 l/ha (Flurochloridone 12.5% ME) |
| 4 | Dose 3: 5 l/ha (Flurochloridone 12.5% ME) |
| 5 | Chemical witness: 4 l/ha (Flurochloridone 25% EC) |

### Work report

a. Cultivation: Sunflower.
b. Site: Lot near the town of Tres Arroyos Province of Buenos Aires.
c. Soil moisture: Good.
d. Application characteristics: The application was carried out on Nov. 30, 2015 in a lot sown the day before with sunflower (DK 3948) in direct sowing. A manual backpack at constant pressure of 35 lb was used by means of CO₂ with 11002 tablets and an application volume of 140 L/ha. The environmental conditions were: 2 km/h wind, 33% relative humidity and 27° C. ambient temperature.
e. Weeds present: The field was clean because a chemical fallow had been carried out approximately 15 days ago with glyphosate and 2,4D to kill the emerged weeds. In any case, a sector of the lot was chosen where a high presence of broadleaf weeds was known.
f. Measured variables: At 19 and 54 days after application (DAA), visual control evaluations were carried out on the emergence of weeds. The data were subjected to an analysis of variance and the means were compared with Fisher's test (DMS) with a p<0.05.
g. Results

The weeds that appeared in the test were Conyza sumatrensis “black branch” and Carduus acanthoides “Chilean thistle”.

Table 2 shows the controls on the black branch. At 19 days, treatments 3, 4 and 5 showed an acceptable control greater than 80%. It was seen that some controlled plants in the fallow were beginning to sprout and on this sprout the control was lower. At 54 days, the controls dropped because there was a very important black branch emergence flow, in any case the trend was the same and no final differences were seen between treatments 3, 4 and 5.

TABLE 2
Test in control % of Conyza Sumatrensis at 19 and
54 days after application.

| Treatments | | 19 DAA | | 54 DAA | |
|---|---|---|---|---|---|
| 1 | Absolute witness | 0.00 | a | 0.00 | a |
| 2 | Dose 1: 3,5 l/ha (Flurochloridone 12,5% ME) | 73.33 | b | 61.67 | b |
| 3 | Dose 2: 4 l/ha (Flurochloridone 12,5% ME) | 83.33 | b | 66.67 | bc |
| 4 | Dose 3: 5 l/ha (Flurochloridone 12,5% ME) | 81.67 | b | 66.67 | bc |
| 5 | Chemical witness: 4 l/ha | 80.00 | bc | 73.33 | c |
| | (Flurochloridone 25% EC) | | | | |
| | CV % | 6.73 | | 7.89 | |
| | DMS | 8.06 | | 7.96 | |

Thistle control was slightly superior to that of black branch. There were also many births of this weed. At 19 days after application, all treatments exceeded 80% control. After 54 days, the control residuality was maintained in the treatments with the highest doses and in the chemical witness (treatments 4 and 5) without showing meaningful differences.

TABLE 3
Test in control % of Carduus acanthoides at 19
and 54 days after application.

| Treatments | | 19 DAA | | 54 DAA | |
|---|---|---|---|---|---|
| 1 | Absolute witness | 0.00 | a | 0.00 | a |
| 2 | Dose 1: 3,5 l/ha (Flurochloridone 12,5% ME) | 81.67 | b | 70.00 | b |
| 3 | Dose 2: 4 l/ha (Flurochloridone 12,5% ME) | 86.67 | b | 75.00 | c |
| 4 | Dose 3: 5 l/ha (Flurochloridone 12,5% ME) | 85.00 | b | 80.00 | d |
| 5 | Chemical witness: 4 l/ha (Flurochloridone 25% EC) | 86.67 | b | 81.67 | d |
| | CV % | 4.03 | | 3.79 | |
| | DMS | 5.15 | | 4.38 | |

### Final Comments

Although the final black branch controls were not totally effective, the higher doses of the product achieved a good initial control, which is where the critical period in sunflower is defined.

Regarding thistle, it was very clear how residual control increased when the dose of flurochloridone was increased.

In this test and these conditions, no notable effects of phytotoxicity were observed in sunflower.

### 3) Comparative Test of Herbicides in Sunflower Pre-Emergence (Flurochloridone 12.5% ME) 15-16

In pre-emergence treatments in the Sunflower crop in full coverage, evaluated in the control of broad leaf weeds common in the Pampean region, susceptible to the chemical molecule under study.

### Proposed Treatments

| Treat. N^{o} | TREATMENT |
|---|---|
| 1 | Absolute witness without application |
| 2 | Dose 1: 3.5 l/ha Flurochloridone 12.5% ME |
| 3 | Dose 2: 4 l/ha Flurochloridone 12.5% ME |
| 4 | Dose 3: 5 l/ha Flurochloridone 12.5% ME |
| 5 | Chemical witness: 4 l/ha Flurochloridone 25% EC |

### Work Report

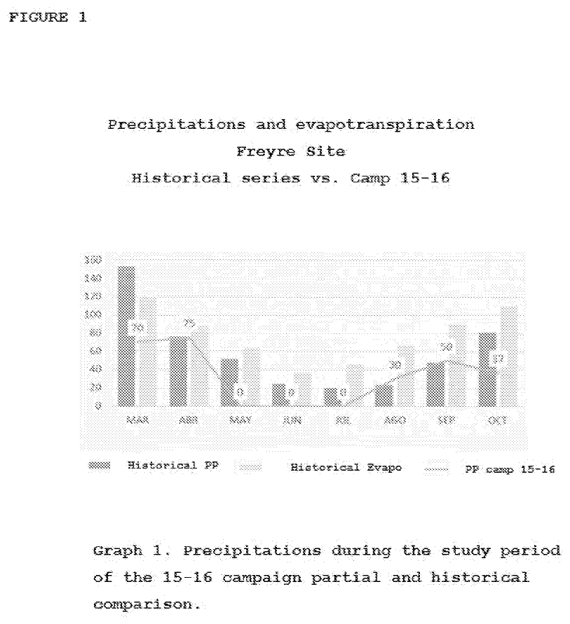

a. Cultivation: Application after the sowing of the Sunflower crop, prior to the emergence of annual grass weeds, of the predecessor Soybean campaign °14-°15. Lot in direct sowing. There was an early application against weeds from the harvest of the mentioned crop based on Glyphosate. Treatments applied on Sep. 27, 2015 (sowing delayed compared to the usual for the region due to excess water in the lot under study).
b. Site: Freyre, San Justo Department, Cordoba Province, soil use class Vw, environment class 2.
c. Weather characteristics: Lot with symptoms of excess water during the 14-15 season. Good environmental conditions during the fallow period, as well as a good history of previous weed controls, given the well-known abundant seed bank of the site, make the lot used in this study a site of good aptitude for the evaluation of the product in question. Temperatures and ambient humidity above the historical values for the surveyed months.
   In the Graph 1 of FIG. 1 is showed Precipitations and evapotranspiration Freyre Site Historical series vs. Camp 15-16
   Weed monitoring: The initial survey was carried out by visiting the lot of 68 hectares in total on a fortnightly basis, walking in an X shape and making the reading in a 2-meter radius per sample, in a total of approximately 1 sample every 10 hectares.

At the time of application, the lot was found to be clean of weeds, 2 days after sowing. Afterwards, sampling was made at 15 and 30 days after application, then recording of the emergence of seedlings susceptible to control (species and quantity) was performed.
e. REGISTERED EMERGENCIES AND APPLICATION INFORMATION

| | | | | | | | | | | Amaranthus | | |
|---|---|---|---|---|---|---|---|---|---|---|---|---|
| | Viola arvensis | | | Carduus sp. | | | Chenopodium album | | | quitensis | | |
| | 0DAA | 15DAA | 30DAA | 0DAA | 15DAA | 30DAA | ODAA | 15DAA | 30DAA | 0DAA | 15DAA | 30DAA |
| Witness | 0 | 8 | 10 | 0 | 5 | 6 | 0 | 6 | 7 | 0 | 6 | 7 |
| Fluro125ME | 0 | 3 | 4 | 0 | 2 | 2 | 0 | 2 | 2 | 0 | 2 | 2 |
| 3.5 lt/ha | | | | | | | | | | | | |
| Fluro125ME | 0 | 2 | 3 | 0 | 2 | 2 | 0 | 1 | 1 | 0 | 1 | 1 |
| 4.0 lt/ha | | | | | | | | | | | | |
| Fluro125ME | 0 | 2 | 2 | 0 | 1 | 1 | 0 | 1 | 0 | 0 | 1 | 0 |
| 5.0 lt/ha | | | | | | | | | | | | |
| Fluro250ME | 0 | 0 | 1 | 0 | 0 | 1 | 10 | 0 | 0 | 0 | 0 | 0 |
| 4.0 lt/ha | | | | | | | | | | | | |
| | | | | | | | | | | Gomphrena | | |
| | | | | | | | | | | pulchella | | |
| | | | | | | | | | | 0DAA | 15DAA | 30DAA |
| | | | | | | | | | Witness | 0 | 4 | 5 |
| | | | | | | | | | Fluro125ME | 0 | 1 | 2 |
| | | | | | | | | | 3.5 lt/ha | | | |
| | | | | | | | | | Fluro125ME | 0 | 1 | 1 |
| | | | | | | | | | 4.0 lt/ha | | | |
| | | | | | | | | | Fluro125ME | 0 | 0 | 0 |
| | | | | | | | | | 5.0 lt/ha | | | |
| | | | | | | | | | Fluro250ME | 0 | 0 | 0 |
| | | | | | | | | | 4.0 lt/ha | | | |

Individuals present per square meter, average value of the three repetitions from each treatment
f. STATISTICAL ANALYSIS

| | | | | |
|---|---|---|---|---|
| Viol15 | 15 | 0.96 | 0.94 | 22.77 |

Analysis of Variance Table (SC type III)

| F. V. | SC | gl | CM | F | p-value |
|---|---|---|---|---|---|
| Model | 103.33 | 4 | 25.83 | 55.36 | <0.0001 |
| Treatment | 103.33 | 4 | 28.83 | 55.36 | <0.0001 |
| Error | 4.67 | 10 | 0.47 | | |
| Total | 108.00 | 14 | | | |

### Test: LSD Fisher Alfa=0.05 DMS=1.24280

### Error: 0.4667 gl: 10

| Treatment | Means | n | E.E. | | | |
|---|---|---|---|---|---|---|
| Witness | 8.00 | 3 | 0.39 | A | | |
| Fluro125ME3.5 | 2.67 | 3 | 0.39 | | B | |
| Fluro125ME4.0 | 2.33 | 3 | 0.39 | | B | |
| Fluro125ME5.0 | 1.67 | 3 | 0.39 | | B | |
| Fluro250ME4.0 | 0.33 | 3 | 0.39 | | | C |

Different letters indicate meaningful differences (p<=0.05)

| | | | | |
|---|---|---|---|---|
| Viol30 | 15 | 0.95 | 0.93 | 23.27 |

Analysis of Variance Table (SC type III)

| F. V. | SC | gl | CM | F | p-value |
|---|---|---|---|---|---|
| Model | 167.33 | 4 | 41.83 | 48.27 | <0.0001 |
| Treatment | 167.33 | 4 | 41.83 | 48.27 | <0.0001 |
| Error | 8.67 | 10 | 0.87 | | |
| Total | 108.00 | 14 | | | |

### Test: LSD Fisher Alfa=0.05 DMS=1.69368

### Error: 0.8667 gl: 10

| Treatment | Means | n | E.E. | | | |
|---|---|---|---|---|---|---|
| Witness | 10.33 | 3 | 0.54 | A | | |
| Fluro125ME3.5 | 3.67 | 3 | 0.54 | | B | |
| Fluro125ME4.0 | 3.33 | 3 | 0.54 | | B | |
| Fluro250ME4.0 | 2.00 | 3 | 0.54 | | B | C |
| Fluro125ME5.0 | 0.67 | 3 | 0.54 | | | C |

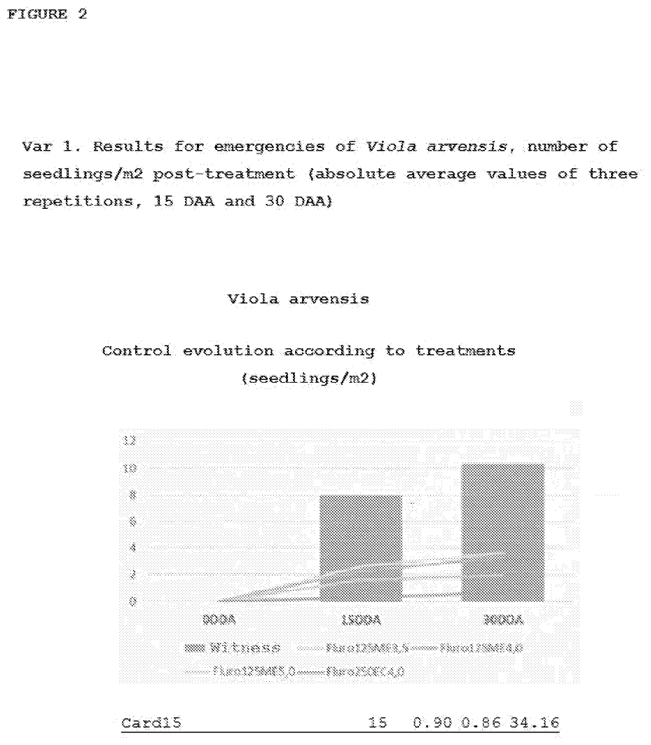

Different letters indicate meaningful differences (p<=0.05)
The FIG. 2 shows Var 1. Results for emergencies of Viola arvensis, number of seedlings/m2 post-treatment (absolute average values of three repetitions, 15 DAA and 30 DAA)
With the following analysis of variance:

### Analysis of Variance Table (SC type III)

| F.V. | SC | gl | CM | F | p-value |
|---|---|---|---|---|---|
| Model | 41.33 | 4 | 10.33 | 22.14 | <0.0001 |
| Treatment | 41.33 | 4 | 10.33 | 22.14 | <0.0001 |
| Error | 4.67 | 10 | 0.47 | | |

| | | |
|---|---|---|
| Total | 46.00 | 14 |

### Test: LSD Fisher Alfa=0.05 DMS=1.24280

### Error: 0.4667 gl: 10

| Treatment | Means | n | E.E. | | | | |
|---|---|---|---|---|---|---|---|
| Witness | 5.00 | 3 | 0.39 | A | | | |
| Fluro125ME3.5 | 2.33 | 3 | 0.39 | | B | | |
| Fluro125ME4.0 | 1.67 | 3 | 0.39 | | B | C | |
| Fluro125ME5.0 | 0.67 | 3 | 0.39 | | | C | D |
| Fluro250ME4.0 | 0.33 | 3 | 0.39 | | | | D |

Different letters indicate meaningful differences (p<=0.05)

| | | | | |
|---|---|---|---|---|
| Card30 | 15 | 0.75 | 0.65 | 47.97 |

Analysis of Variance Table (SC type III)

| F. V. | SC | gl | CM | F | p-value |
|---|---|---|---|---|---|
| Model | 41.73 | 4 | 10.43 | 7.45 | <0.0047 |
| Treatment | 41.73 | 4 | 10.43 | 7.45 | <0.0047 |
| Error | 14.00 | 10 | 1.40 | | |
| Total | 55.73 | 14 | | | |

### Test: LSD Fisher Alfa=0.05 DMS=2.15259

### Error: 1.4000 gl: 10

| Treatment | Means | n | E.E. | | |
|---|---|---|---|---|---|
| Witness | 5.67 | 3 | 0.68 | A | |
| Fluro125ME3.5 | 2.33 | 3 | 0.68 | | B |
| Fluro125ME4.0 | 2.00 | 3 | 0.68 | | B |
| Fluro250ME4.0 | 1.33 | 3 | 0.68 | | B |
| Fluro125ME5.0 | 1.00 | 3 | 0.65 | | B |

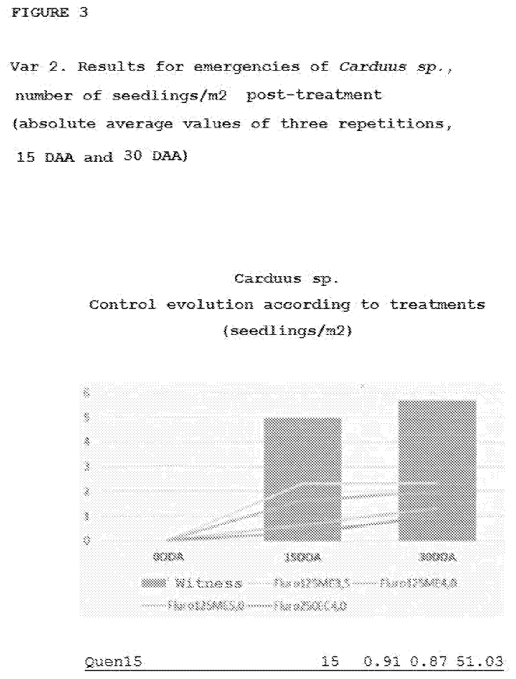

Different letters indicate meaningful differences (p<=0.05)
In FIG. 3 is showed Var 2. Results for emergencies of Carduus sp., number of seedlings/m2 post-treatment (absolute average values of three repetitions, 15 DAA and 30 DAA).
With the following analysis of variance:

### Analysis of Variance Table (SC type III)

| F.V. | SC | gl | CM | F | p-value |
|---|---|---|---|---|---|
| Model | 64.93 | 4 | 16.23 | 24.35 | <0.0001 |
| Treatment | 64.93 | 4 | 16.23 | 24.35 | <0.0001 |
| Error | 6.67 | 10 | 0.67 | | |
| Total | 71.60 | 14 | | | |

### Test: LSD Fisher Alfa=0.05 DMS=1.48543

### Error: 0.6667 gl: 10

| Treatment | Means | n | E.E. | | |
|---|---|---|---|---|---|
| Witness | 5.67 | 3 | 0.47 | A | |
| Fluro125ME3. 5 | 1.33 | 3 | 0.47 | | B |
| Fluro125ME4.0 | 0.67 | 3 | 0.47 | | B |
| Fluro125ME5.0 | 0.33 | 3 | 0.47 | | B |
| Fluro250ME4.0 | 0.00 | 3 | 0.47 | | B |

Different letters indicate meaningful differences (p<=0.05)

| | | | | |
|---|---|---|---|---|
| Quen30 | 15 | 0.93 | 0.90 | 39.51 |

Analysis of Variance Table (SC type III)

| F. V. | SC | gl | CM | F | p-value |
|---|---|---|---|---|---|
| Model | 82.27 | 4 | 20.57 | 30.85 | <0.0001 |
| Treatment | 82.27 | 4 | 20.57 | 30.85 | <0.0001 |
| Error | 6.67 | 10 | 0.67 | | |
| Total | 88.93 | 14 | | | |

### Test: LSD Fisher Alfa=0.05 DMS=1.48543

### Error: 0.6667 gl: 10

| Treatment | Means | n | E.E. | | |
|---|---|---|---|---|---|
| Witness | 6.67 | 3 | 0.47 | A | |
| Fluro125ME3.5 | 1.67 | 3 | 0.47 | | B |
| Fluro125ME4.0 | 1.00 | 3 | 0.47 | | B |
| Fluro250ME4.0 | 0.67 | 3 | 0.47 | | B |
| Fluro125ME5.0 | 0.33 | 3 | 0.47 | | B |

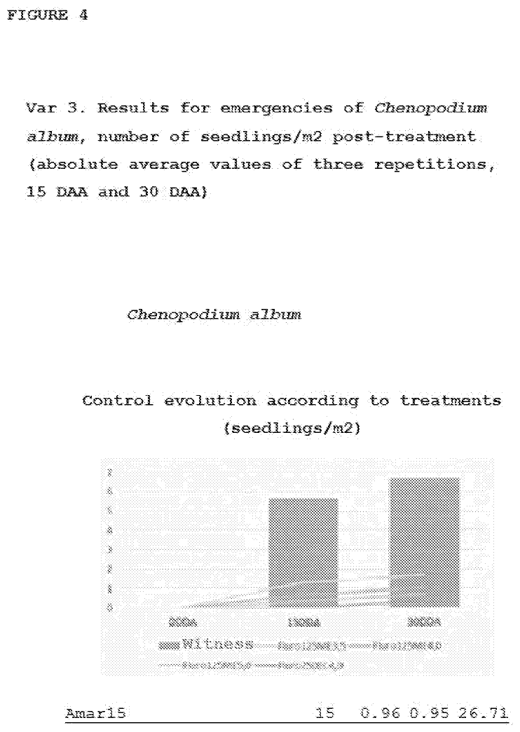

Different letters indicate meaningful differences (p<=0.05)
In FIG. 4 is showed Var 3. Results for emergencies of Chenopodium album, number of seedlings/m2 post-treatment (absolute average values of three repetitions, 15 DAA and 30 DAA).
With the following analysis of variance:

### Analysis of Variance Table (SC type III)

| F.V. | SC | gl | CM | F | p-value |
|---|---|---|---|---|---|
| Model | 68.27 | 4 | 17.07 | 64.00 | <0.0001 |
| Treatment | 68.27 | 4 | 17.07 | 64.00 | <0.0001 |
| Error | 2.67 | 10 | 0.27 | | |
| Total | 70.93 | 14 | | | |

### Test: LSD Fisher Alfa=0.05 DMS=0.93947

### Error: 0.2667 gl: 10

| Treatment | Means | n | E.E. | | | | |
|---|---|---|---|---|---|---|---|
| Witness | 6.00 | 3 | 0.30 | A | | | |
| Fluro125ME3.5 | 2.00 | 3 | 0.30 | | B | | |
| Fluro125ME4.0 | 1.00 | 3 | 0.30 | | | C | |
| Fluro125ME5.0 | 0.67 | 3 | 0.30 | | | C | D |
| Fluro250ME4.0 | 0.00 | 3 | 0.30 | | | | D |

Different letters indicate meaningful differences (p<=0.05)

| | | | | |
|---|---|---|---|---|
| Amar30 | 15 | 0.95 | 0.93 | 34.23 |

### Analysis of Variance Table (SC type III)

| F.V. | SC | gl | CM | F | p-value |
|---|---|---|---|---|---|
| Model | 94.40 | 4 | 23.60 | 44.25 | <0.0001 |
| Treatment | 94.40 | 4 | 23.60 | 44.25 | <0.0001 |
| Error | 5.33 | 10 | 0.53 | | |
| Total | 99.73 | 14 | | | |

### Test: LSD Fisher Alfa=0.05 DMS=1.32861

### Error: 0.5333 gl: 10

| Treatment | Means | n | E.E. | | | |
|---|---|---|---|---|---|---|
| Witness | 7.00 | 3 | 0.42 | A | | |
| Fluro125ME3.5 | 2.00 | 3 | 0.42 | | B | |
| Fluro125ME4.0 | 1.00 | 3 | 0.42 | | B | C |
| Fluro250ME4.0 | 0.33 | 3 | 0.42 | | | C |
| Fluro125ME5.0 | 0.33 | 3 | 0.42 | | | C |

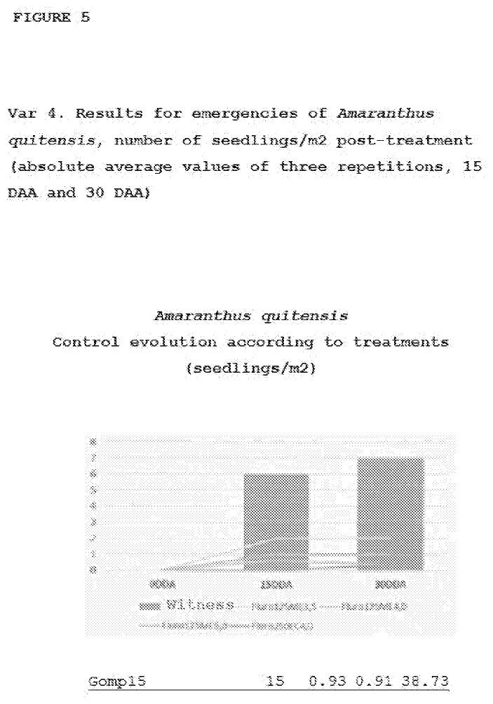

Different letters indicate meaningful differences (p<=0.05)
In FIG. 5 is showed Var 4. Results for emergencies of Amaranthus quitensis, number of seedlings/m2 post-treatment (absolute average values of three repetitions, 15 DAA and 30 DAA)
With the following analysis of variance:

### Analysis of Variance Table (SC type III)

| F.V. | SC | gl | CM | F | p-value |
|---|---|---|---|---|---|
| Model | 36.67 | 4 | 9.17 | 34.38 | <0.0001 |
| Treatment | 36.67 | 4 | 9.17 | 34.38 | <0.0001 |
| Error | 2.67 | 10 | 0.27 | | |
| Total | 39.33 | 14 | | | |

### Test: LSD Fisher Alfa=0.05 DMS=0.93947

### Error: 0.2667 gl: 10

| Treatment | Means | n | E.E. | | | |
|---|---|---|---|---|---|---|
| Witness | 4.33 | 3 | 0.30 | A | | |
| Fluro125ME3.5 | 1.33 | 3 | 0.30 | | B | |
| Fluro125ME4.0 | 0.67 | 3 | 0.30 | | B | C |
| Fluro125ME5.0 | 0.33 | 3 | 0.30 | | | C |
| Fluro250ME4.0 | 0.00 | 3 | 0.30 | | | C |

Different letters indicate meaningful differences (p<=0.05)

| | | | | |
|---|---|---|---|---|
| Gomp30 | 15 | 0.91 | 0.87 | 42.70 |

Analysis of Variance Table (SC type III)

| F.V. | SC | gl | CM | F | p-value |
|---|---|---|---|---|---|
| Model | 46.93 | 4 | 11.73 | 25.14 | <0.0001 |
| Treatment | 46.93 | 4 | 11.73 | 25.14 | <0.0001 |
| Error | 4.67 | 10 | 0.47 | | |
| Total | 51.60 | 14 | | | |

### Test: LSD Fisher Alfa=0.05 DMS=1.24280

### Error: 0.4667 gl: 10

| Treatment | Means | n | E.E. | | | |
|---|---|---|---|---|---|---|
| Witness | 5.00 | 3 | 0.39 | A | | |
| Fluro125ME3.5 | 1.67 | 3 | 0.39 | | B | |
| Fluro125ME4.0 | 0.67 | 3 | 0.39 | | B | C |
| Fluro250ME4.0 | 0.33 | 3 | 0.39 | | | C |
| Fluro125ME5.0 | 0.33 | 3 | 0.39 | | | C |

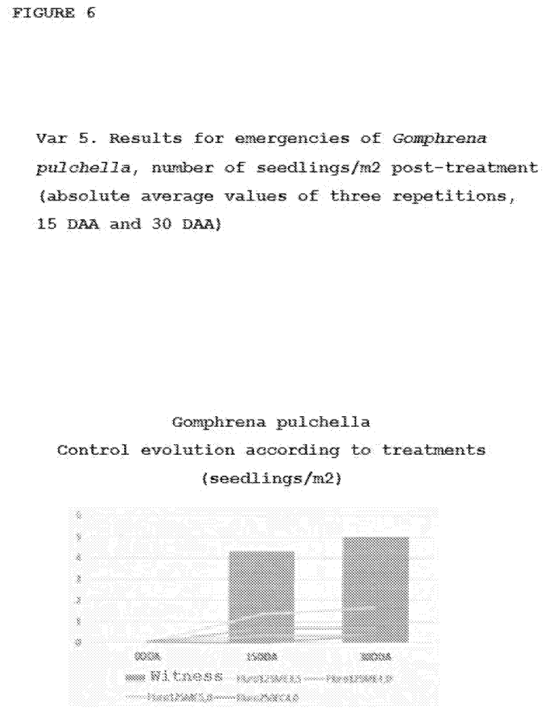

Different letters indicate meaningful differences (p<=0.05)
In FIG. 6 is showed Var 5. Results for emergencies of Gomphrena pulchella, number of seedlings/m2 post-treatment (absolute average values of three repetitions, 15 DAA and 30 DAA)

### Comments

The product evaluated in this study exhibited a performance comparable to a good extent to that shown by the chemical witness, directly dependent on the test dose and the biological characteristics of each weed species present and taking into account the differences in concentration and formulation of the tested products.

### GENERAL CONCLUSIONS OF COMPARATIVE TESTS 1), 2) AND 3)

### 1) Comparative Test of Herbicides in Sunflower Pre-Emergence (Broad Leaf) (Flurochloridone 12.5% ME) 14-15

### Conclusion

The formulation of flurochloridone 12.5% ME had an efficient control over the weeds evaluated in the test. The 5 l/ha dose of flurochloridone 12.5% ME (treatment 3) showed the same performance compared to the doses of the commercial witness (flurochloridone 25% EC 4 l/ha). From these results we can conclude that the reduction of active ingredient per hectare translates into 37.5% compared to the chemical witness of proven efficacy in the market.

### 2) Comparative Test of Herbicides in Sunflower Pre-Emergence (Flurochloridone 12.5% ME) 15-16

### Conclusion

The formulation of flurochloridone 12.5% ME had an efficient control over the weeds evaluated in the test. The 5 l/ha dose of flurochloridone 12.5% ME (treatment 4) showed the same performance compared to the doses of the commercial witness (flurochloridone 25% EC 4 l/ha). From these results we can conclude that the reduction of active ingredient per hectare translates into 37.5% compared to the chemical witness of proven efficacy in the market.

### 3) Comparative Test of Herbicides in Sunflower Pre-Emergence (Flurochloridone 12.5% ME) 15-16

### Conclusion

The formulation of flurochloridone 12.5% ME had an efficient control over the weeds evaluated in the test. The 5 l/ha dose of flurochloridone 12.5% ME (treatment 4) showed the same performance compared to the doses of the commercial witness (flurochloridone 25% EC 4 l/ha). From these results we can conclude that the reduction of active ingredient per hectare translates into 37.5% compared to the chemical witness of proven efficacy in the market.

1. A flurochloridone composition in the form of a microemulsion comprising from 5 to 20% weight by volume (w/v) of flurochloridone, a solvent or a mixture of polar or non-polar, soluble or insoluble solvents in water, comprising from 35 to 45% w/v, a polar cosolvent or mixture of polar cosolvents comprising from 8 to 13% w/v, a mixture of non-ionic surfactants comprising from 6% to 12% w/v, an anionic surfactant comprising from 9.5% to 10% w/v, a co-adjuvant comprising from 2% to 25.0% w/v, water from 2.0% to 6.0% w/v and a defoamer comprising from 0.05% w/v to 0.5% w/v.

2. The flurochloridone composition in the form of a microemulsion according to claim 1, wherein the solvent or mixture of polar or non-polar, soluble or insoluble solvents in water, comprising from 35 to 45% w/v is selected as water-soluble solvent cyclohexanone, dimethylsulfoxide (DMSO), dioxolane, methyl ethyl ketone (MEK), acetone, and as a water-insoluble solvent dibasic ester (DBE), or xylene; or mixtures thereof.

3. The flurochloridone composition in the form of a microemulsion according to claim 1, wherein the polar cosolvent is selected from N-methylpyrrolidone, N-octylpyrrolidone or a mixture thereof.

4. The flurochloridone composition in the form of a microemulsion according to claim 1, wherein the mixture of non-ionic surfactants comprising from 6% to 12% w/v is selected from polyalkylene oxide block copolymer (Atlas G5002L®) and 10 mol EO nonylphenol ethoxylate.

5. The flurochloridone composition in the form of a microemulsion according to claim 4, wherein the amount of polyalkylene oxide block copolymer in the composition ranges between 3.0% w/v to 7.0% w/v.

6. The flurochloridone composition in the form of a microemulsion according to claim 4, wherein the amount of 10 mol EO nonylphenol ethoxylate in the composition ranges between 3% w/v to 5.0% w/v.

7. The flurochloridone composition in the form of a microemulsion according to claim 1, wherein the anionic surfactant is selected from calcium dodecylbenzenesulfonate (FS Ca) at 60% or 70% w/w in isobutanol.

8. The flurochloridone composition in the form of a microemulsion according to claim 1, wherein the co-adjuvant is selected from oil fatty acid methyl esters (FAME) of vegetal oil as soybean oil, coconout oil, palm oil, palm kernel oil, corn oil, olive oil or oilseed rape and tallow.

9. The flurochloridone composition in the form of a microemulsion according to claim 1, wherein the defoamer comprises a silicone defoamer.

10. The flurochloridone composition in the form of a microemulsion according to claim 1, comprising the following list of components:

| Component | % w/v |
|---|---|
| Cyclohexanone | 42.50 |
| N-methylpyrrolidone | 8.50 |
| Flurochloridone | 12.50 |
| FAME | 11.00 |
| Polyalkylene oxide block copolymer | 6.00 |
| 10 EO Nonylphenol | 4.80 |
| FS Ca 70% | 9.00 |
| Water | 6.00 |
| Defoamer | 0.05 |

11. The flurochloridone composition in the form of a microemulsion according to claim 1, comprising the following list of components:

| Component | % w/v |
|---|---|
| Cyclohexanone | 40.00 |
| N-methylpyrrolidone | 8.00 |
| Flurochloridone | 5.00 |
| FAME | 15.00 |
| Polyalkylene oxide block copolymer | 6.00 |
| 10 EO Nonylphenol | 5.00 |
| FS Ca 70% | 9.00 |
| Water | 15.00 |
| Defoamer | 0.5 |

12. The flurochloridone composition in the form of a microemulsion according to claim 1, comprising the following list of components:

| Component | % w/v |
|---|---|
| Cyclohexanone | 45.00 |
| N-methylpyrrolidone | 13.00 |
| Flurochloridone | 20.00 |
| FAME | 2.00 |
| Polyalkylene oxide block copolymer | 7.00 |
| 10 EO Nonylphenol | 5.00 |
| FS Ca 70% | 9.50 |
| Water | 2.00 |
| Defoamer | 0.5 |

13. The flurochloridone composition in the form of a microemulsion according to claim 1, comprising the following list of components:

| Component | % w/v |
|---|---|
| Cyclohexanone | 35.00 |
| N-methylpyrrolidone | 5.00 |
| Flurochloridone | 5.00 |
| FAME | 15.00 |
| polyalkylene oxide block copolymer | 3.00 |
| 10 EO Nonylphenol | 3.00 |
| FS Ca 70% | 6.00 |
| Water | 28.00 |
| Defoamer | 0.5 |

14. The flurochloridone composition in the form of a microemulsion according to claim 2, comprising the following list of components:

| Component | % w/v |
|---|---|
| Cyclohexanone | 42.50 |
| N-methylpyrrolidone | 8.50 |
| Flurochloridone | 12.50 |
| FAME | 11.00 |
| Polyalkylene oxide block copolymer | 6.00 |
| 10 EO Nonylphenol | 4.80 |
| FS Ca 70% | 9.00 |
| Water | 6.00 |
| Defoamer | 0.05 |

15. The flurochloridone composition in the form of a microemulsion according to claim 3, comprising the following list of components:

| Component | % w/v |
|---|---|
| Cyclohexanone | 42.50 |
| N-methylpyrrolidone | 8.50 |
| Flurochloridone | 12.50 |
| FAME | 11.00 |
| Polyalkylene oxide block copolymer | 6.00 |
| 10 EO Nonylphenol | 4.80 |
| FS Ca 70% | 9.00 |
| Water | 6.00 |
| Defoamer | 0.05 |

16. The flurochloridone composition in the form of a microemulsion according to claim 2, comprising the following list of components:

| Component | % w/v |
|---|---|
| Cyclohexanone | 40.00 |
| N-methylpyrrolidone | 8.00 |
| Flurochloridone | 5.00 |
| FAME | 15.00 |
| Polyalkylene oxide block copolymer | 6.00 |
| 10 EO Nonylphenol | 5.00 |
| FS Ca 70% | 9.00 |
| Water | 15.00 |
| Defoamer | 0.5 |

17. The flurochloridone composition in the form of a microemulsion according to claim 3, comprising the following list of components:

| Component | % w/v |
|---|---|
| Cyclohexanone | 40.00 |
| N-methylpyrrolidone | 8.00 |
| Flurochloridone | 5.00 |
| FAME | 15.00 |
| Polyalkylene oxide block copolymer | 6.00 |
| 10 EO Nonylphenol | 5.00 |
| FS Ca 70% | 9.00 |
| Water | 15.00 |
| Defoamer | 0.5 |

18. The flurochloridone composition in the form of a microemulsion according to claim 2, comprising the following list of components:

| Component | % w/v |
|---|---|
| Cyclohexanone | 45.00 |
| N-methylpyrrolidone | 13.00 |
| Flurochloridone | 20.00 |
| FAME | 2.00 |
| Polyalkylene oxide block copolymer | 7.00 |
| 10 EO Nonylphenol | 5.00 |
| FS Ca 70% | 9.50 |
| Water | 2.00 |
| Defoamer | 0.5 |

19. The flurochloridone composition in the form of a microemulsion according to claim 3, comprising the following list of components:

| Component | % w/v |
|---|---|
| Cyclohexanone | 45.00 |
| N-methylpyrrolidone | 13.00 |
| Flurochloridone | 20.00 |
| FAME | 2.00 |
| Polyalkylene oxide block copolymer | 7.00 |
| 10 EO Nonylphenol | 5.00 |
| FS Ca 70% | 9.50 |
| Water | 2.00 |
| Defoamer | 0.5 |

20. The flurochloridone composition in the form of a microemulsion according to claim 4, comprising the following list of components:

| Component | % w/v |
|---|---|
| Cyclohexanone | 45.00 |
| N-methylpyrrolidone | 13.00 |
| Flurochloridone | 20.00 |
| FAME | 2.00 |
| Polyalkylene oxide block copolymer | 7.00 |
| 10 EO Nonylphenol | 5.00 |
| FS Ca 70% | 9.50 |
| Water | 2.00 |
| Defoamer | 0.5 |
